(19) United States
(12) Patent Application Publication
(10) Pub. No.: US 2024/0025688 A1
(43) Pub. Date: Jan. 25, 2024

(54) ADDITIVELY MANUFACTURED GUIDE ROLLER

(71) Applicant: manroland Goss web systems GmbH, Augsburg (DE)

(72) Inventors: Siegmund Echerer, Thierhaupten (DE); Erich Stöckle, Donauwörth (DE); Michael Blumhöfer, Rehling (DE)

(73) Assignee: manroland Goss web systems GmbH, Augsburg (DE)

(21) Appl. No.: 18/224,485

(22) Filed: Jul. 20, 2023

(30) Foreign Application Priority Data
Jul. 22, 2022 (DE) 10 2022 118 390.4

(51) Int. Cl. B65H 27/00

(52) U.S. Cl. CPC B65H 27/00; B65H 2404/1116; B33Y 80/00

(57) ABSTRACT

A guide roller and a method for manufacturing a guide roller combines a cost-efficient manufacture and hard, wear-resistant webs for contact with a substrate. An at least one web consists of a second material which differs from a first material of a base body. The webs or the at least one web is applied to the base body by means of a deposition welding process, a thermal spraying process, a plasma transferred arc spraying process, a laser deposition welding process, or by means of an additive manufacturing process. Guide rollers of this type are used on machines that process substrate webs or substrate strands, such as web-fed printing presses, systems for processing already printed substrate webs or similar systems.

### CROSS-REFERENCE TO RELATED APPLICATION

This United States non-provisional application claims the benefit of priority to the filing date of German Application No. DE 10 2022 118 390.4 filed on Jul. 22, 2022.

### FIELD OF THE INVENTION

The present invention relates to a polygon roller, which is designed as a guide roller for guiding and/or deflecting substrate webs in machines that process substrate, wherein the guide roller comprises a polygon body, wherein the polygon body comprises a base body made of a first material, wherein, over the circumference of the base body, the polygon body comprises at least one web applied to the base body.

The invention furthermore relates to a method for producing a guide roller of this type.

### BACKGROUND OF THE INVENTION AND RELATED ART

Guide rollers are used on machines that process substrate webs or substrate strands, such as, for example, web-fed printing presses, systems for processing already printed substrate webs or similar systems, in order to guide an unprinted substrate web as well as one or several already printed substrate webs or a partial web cut from a substrate web or a plurality of substrate webs located one on top of the other or a plurality of partial webs located one on top of the other.

Guide rollers in various designs are used for this purpose, which essentially comprise a rotatably mounted roller body, which is generally partially wrapped by the at least one substrate web or partial substrate web, which is to be guided. The jacket surfaces of the roller body, which are in contact with the substrate web, are either embodied cylindrically, have grooves incorporated into the jacket surfaces with usually small cross-section for the trapped air to escape, or the roller bodies are embodied as so-called polygon rollers with a cross-section, which is not purely cylindrical. Polygon rollers of this type have turned out to be highly advantageous for guiding web-shaped substrates of this type due to small web runs, very small formation of creases, and web tension, which remains highly consistent even in response to strong deflection and thus very strong wrapping of at least one substrate web or partial substrate webs.

Guide rollers of this type with polygonal cross-section of the roller body are already known from the prior art.

DE 10 2007 039 487 A1 discloses a web guide roller, on the jacket surface of which elevations are formed in the extension of the axis of rotation, thus resulting in a cross-section of the web guide roller, which is formed as a polygon.

DE 198 57 123 C1 discloses a guide roller comprising elevations and depressions on the effective jacket surface, wherein the elevations and depressions are incorporated helically into the jacket surface.

Depending on the angle of the elevations and depressions to the axis of rotation of a guide roller of this type, the transition between a polygon roller and a web guide roller comprising a helical groove is smooth because a polygonal cross-section of the guide roller likewise results in the case of a correspondingly acute angle of the elevations and/or depressions to the axis of rotation.

However, the manufacture of polygon rollers of this type is relatively complex because webs of this type or the grooves located between the webs, respectively, have to be machined out of the material of the guide roller, which is possible, for example, by means of milling in the case of axially parallel webs or in the case of helical webs. Even though materials with a low hardness, such as aluminum, for example, can be processed relatively cost-efficiently thereby, they are characterized by a higher wear due to the contact with the substrate web. However, materials with a higher hardness, such as steel, for example, in particular high-strength steel, can only be machined in a highly complex manner, even though polygon rollers of this type are characterized by higher wear resistance.

### OBJECT AND SUMMARY OF THE INVENTION

It is thus the object of the invention to create a guide roller as well as a method for producing a guide roller, which combines a cost-efficient manufacture on the one hand and hard, wear-resistant webs, which are in contact with the substrate, on the other hand.

The object is achieved in that the at least one web consists of a second material, which differs from the first material. The object is further achieved by means of a method, in the case of which the webs or the at least one web is applied to the base body by means of a deposition welding process, a thermal spraying process, a plasma transferred arc spraying process, a laser deposition welding process, or by means of an additive manufacturing process.

On the one hand, this provides for a cost-efficient manufacture, and a high wear-resistance can be ensured simultaneously when using very hard materials as the second material.

According to one embodiment of the invention, the base body of the polygon body has an essentially cylindrical jacket surface, which is arranged around the longitudinal axis. A component or semi-finished product in the form of a tube or of a cylinder, which can be produced in a highly cost-efficient manner, can thus be used as a starting product for the polygon roller.

It is also possible to at least partially coat the base body, which consists of the first material, with a coating made of a third material, which differs from the first material.

The second material and thus the material of the at least one web can be a metal, a metal alloy, or a ceramic.

A wear-resistance steel or a non-iron material or a non-iron alloy, such as tungsten, a tungsten alloy, nickel, or a nickel-base alloy, for example, can be used as the metal or the metal alloy of the second material.

If a ceramic is used as the second material, the ceramic can consist of a molten oxide ceramic powder, i.e. ceramic powder with, for example, yttrium oxide-stabilized zirconium oxide, yttrium oxide, aluminum oxide, chromium oxide, titanium oxide, lanthanum-strontium manganite as a base.

According to a further embodiment of the invention, an adhesive layer is attached to the base body and/or to the coating attached to the base body in the region of the at least one web made of the second material. An embodiment of this type can be expedient as a function of the material combination first material/second material, in order to increase the adhesion of the second material on the base body or the coating applied to the base body.

Further aspects of the invention follow from the following detailed description. Various exemplary embodiments of the invention will be described in more detail on the basis of the accompanying drawings, without being limited thereto.

### BRIEF DESCRIPTION OF THE DRAWINGS

FIG. 1a shows a first exemplary embodiment of a guide roller designed as a polygon comprising helically arranged webs.

FIG. 1b shows a second exemplary embodiment of a guide roller designed as a polygon roller comprising axially parallel webs.

FIG. 1c shows a third exemplary embodiment of a guide roller designed as a polygon roller comprising a spiral web.

FIG. 2 shows a section of a base body made of a first material comprising applied webs made of a second material.

FIG. 3 shows a section of a base body made of a first material comprising applied webs made of a second material comprising a coating of the base body.

FIG. 4 shows an exemplary embodiment of webs made of the second material comprising a base body, which is visible between the webs.

FIG. 5 shows an exemplary embodiment of webs made of the second material comprising a second material arranged between the webs.

### DETAILED DESCRIPTION OF EXEMPLARY EMBODIMENTS

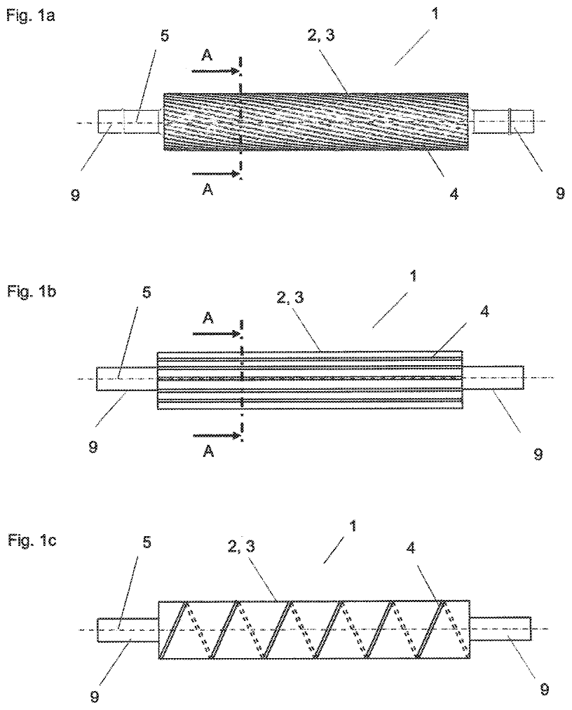

FIG. 1a to FIG. 1c show various exemplary embodiments of guide rollers 1 according to the invention, which are designed as polygon rollers.

FIG. 1a, FIG. 1b, and FIG. 1c each show a guide roller 1 comprising a polygon body 2, which is in contact with an at least one substrate web (not shown), which is to be transported or deflected, or with an at least one partial substrate web (not shown) when used in a substrate-processing machine.

The exemplary embodiments illustrated in FIG. 1a to FIG. 1c show a guide roller 1, which comprises a respective roller journal 9 on both sides of the polygon body 2, which is connected in a positive manner, a non-positive manner, or by means of a substance-to-substance bond to the polygon body 2. Slide bearings or roller bearings can be attached to these roller journals 9, so that the guide roller 1 as a whole can be rotated about the longitudinal axis 5.

However, the invention also relates to an embodiment of a guide roller 1 comprising a polygon body 2, in the case of which the polygon body 2 is mounted on a support axis by means of slide bearings or roller bearings, so that the support axis can be fastened to at least one side wall or to a frame in the case of this embodiment.

Due to the rotatable mounting of the polygon body 2 on the support axis, the polygon body and therefore also the guide roller 1 is thus rotatably mounted about the longitudinal axis 5 of the guide roller 1.

The polygon body 2 illustrated in FIG. 1a to FIG. 1c comprises a base body 3, to which at least one web 4 is attached by means of a substance-to-substance bond. In the case of most embodiments, a plurality of webs 4 is attached by means of a substance-to-substance bond to the base body 3, in order to obtain a polygonal cross-section by means of the grooves resulting from the plurality of the webs 4 applied to the base body 3.

FIG. 1a shows an exemplary embodiment of a guide roller 1 comprising a plurality of webs 4, which are arranged on the polygon body 2 and which are helically applied to the base body 3. The webs 4 have an acute angle between the longitudinal axis 5 and each web 4. This angle lies in a range of 10° to 40°, preferably between 15° and 35°.

FIG. 1b shows an exemplary embodiment of a guide roller 1 comprising a plurality of webs 4 attached to the polygon body 2, wherein the webs 4 are arranged parallel or, in consideration of manufacture tolerances, essentially parallel to the longitudinal axis 5.

While a polygonal cross-section undoubtedly results in the case of the embodiments illustrated in FIG. 1a and FIG. 1b comprising a plurality of webs 4 arranged on the jacket surface 6 of the base body 3, this is not visible at first glance in the case of guide rollers 1 with a larger angle between the at least one web 4, which is spirally arranged on the base body 3. Due to the fact, however, that the angle drawn between a web 4 and the longitudinal axis 5 is only of minor importance for the invention, for the sake of completeness the invention will also be described on the basis of a guide roller 1 comprising only one spirally arranged web 4.

Guide rollers 1, in the case of which the webs 4 run essentially perpendicular to the longitudinal axis 5, can undoubtedly not be referred to as guide roller 1 with a polygonal cross-section due to the cross-section, which is then always circular.

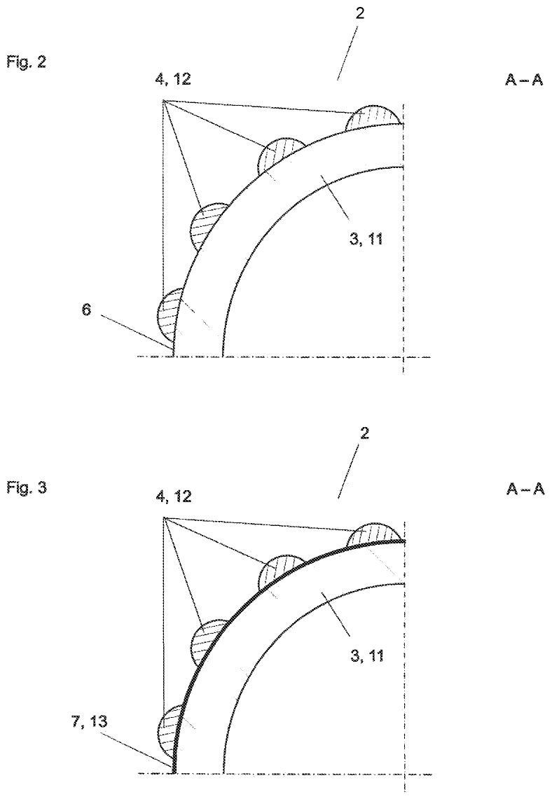

FIG. 2 shows a section of the cross-section A-A through the polygon body 2 from FIG. 1a or FIG. 1b in an exemplary embodiment. It can be seen thereby that the polygon body 2 comprises a base body 3 comprising an essentially cylindrical jacket surface 6, which is preferably arranged around the longitudinal axis 5. The base body 3 consists of a first material 11, wherein the first material 11 is preferably a metal, such as aluminum, an aluminum alloy, steel, or a steel alloy.

The polygon body 2 further comprises webs 4, which are attached by means of a substance-to-substance bond to the jacket surface 6 of the base body 3, wherein the webs 4 consist of a second material 12, wherein the second material 12 is a material which differs from the first material 11.

The second material 12 is preferably a metal or a metal alloy, such as, for example, a wear-resistant steel or a non-iron material, or a non-iron alloy, such as, for example, tungsten, a tungsten alloy, nickel, or a nickel-base alloy. In the alternative, a ceramic, such as, for example, an oxide ceramic material, can also be used as second material 12, whereby the ceramic or the oxide ceramic consists of molten powder.

For the manufacture of a polygon body 2 of this type comprising a base body 3 made of a first material 11 and webs 4 arranged thereon in a helical or axially parallel manner, the at least one web 4 can be applied to the base body 3, for example by means of a deposition welding process, a thermal spraying process, a plasma transferred arc spraying process, a laser deposition welding process, or by means of an additive manufacturing process, such as, for example, three dimensional (3D) printing.

Analogously to FIG. 2, FIG. 3 shows a section of the cross-section A-A through the polygon body 2 from FIG. 1a or FIG. 1b in an exemplary embodiment, wherein the polygon body 2 comprises a base body 3 and a number of webs 4 attached thereon. However, FIG. 3 shows an exemplary embodiment of the invention, in the case of which the base body 3 at least partially has a coating 7 on its outer jacket surface 6. This coating 7 can be embodied with a third material 13 or, in the alternative, with the second material 12, in order to increase, for example, the wear resistance or the corrosion resistance of the base body 3 by means of this coating 7, which is why, when applying a third material 13, the latter differs from the first material 11 of the base body 3. With regard to its thickness, the coating 7 is generally significantly smaller than the height of the webs 4.

Although not illustrated, it is also possible and also advantageous in the case of certain combinations of the first material 11, second material 12 and/or third material 13, to apply an adhesive layer to the base body 3 and/or to the optional coating 7 at least in the region of the at least one web 4 or in the region of the plurality of the webs 4, which is made of the second material 12. An adhesive layer of this type increases the adhesion of the at least one web 4 on the base body 3 or on the jacket surface 6 of the coating 7 applied base body 3.

In the alternative, it is also possible to embody the adhesive layer as coating 7, as illustrated in FIG. 3, so that the adhesive layer is not only applied in the region of the at least one web 4 or in the region of the plurality of the webs 4. Depending on the coating method for the adhesive layer and on the material costs for the adhesive layer, this can be advantageous with regard to the production costs.

Although not illustrated, it is thus also possible to at least partially coat the polygon body 2, which comprises the base body 3 and the at least one web 4, with a plating. The plating can be made of a material, which thus also increases, for example, the wear resistance of the at least one web 4 or which has an ink-repelling effect, for example, to avoid so-called depositing, which can be advantageous when using a corresponding guide roller 1 in the case of printed substrates.

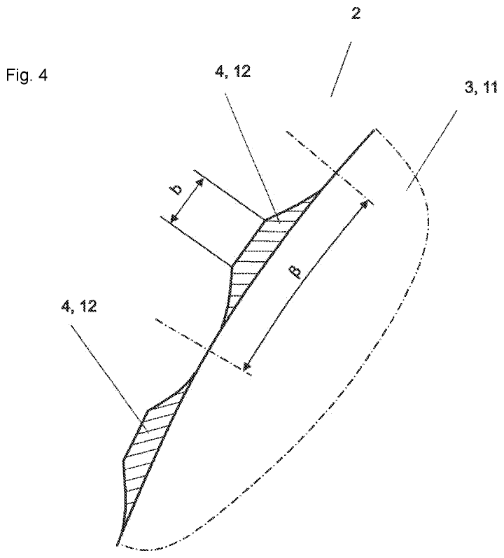

FIG. 4 shows an exemplary embodiment of a guide roller 1 according to the invention, wherein FIG. 4, in turn, similarly as in FIG. 2 and FIG. 3, shows a section from the cross-section of the polygon body 2.

FIG. 4 thus shows a section from the base body 3 made of the first material 11, onto which a plurality of webs 4 made of a second material 12 are applied by means of a substance-to-substance bond. When applying the webs 4 by means of a welding process (for example deposition welding process, thermal spraying process, plasma transferred arc spraying process, laser deposition welding process, etc.), the flanks result, which typically slope concavely, as well as a mostly rounded tip of the webs 4. Due to these surfaces of the webs 4, which are designed within relatively broad tolerances, by means of the relevant welding processes, the contact surface is thus defined only conditionally by the webs 4 comprising the substrate web, the effective radii of the respective webs 4 can also fluctuate based on the longitudinal axis 5.

According to an exemplary embodiment of the invention, the at least one web 4, which is attached to the base body 3, is machined after the deposition welding in order to ensure identical outermost radial extension based on the longitudinal axis 5. In addition to a consistently effective radius for all webs 4 based on the longitudinal axis 5, this also ensures the advantage that the outer surface of a web 4, which is in operative connection with the substrate, has a section of a cylindrical jacket surface.

The web width b typically lies in a range of 1 to 10 mm, preferably in the range of 1.5 to 5 millimeters. As a function of the web width b, the contour of the web 4, and the diameter of the polygon body 2, the pitch angle β lies in a range of 5° to 25°, preferably in a range of 5° to 15°.

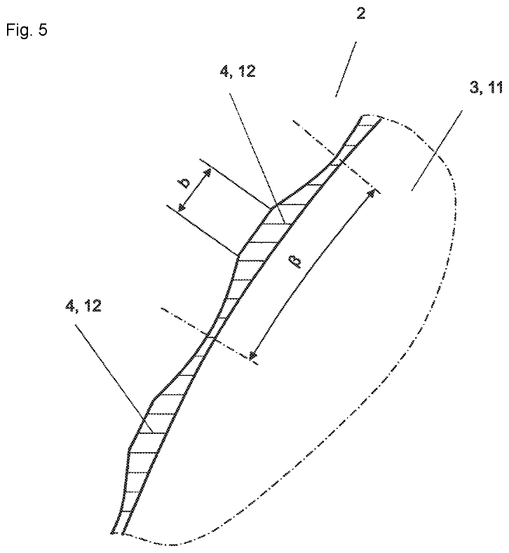

FIG. 5 shows a further exemplary embodiment of the polygon body 2, in the case of which the second material 12, of which the webs 4 consist, is also applied to the base body 3 between the webs 4, so that the jacket surface 6 of the base body 3 made of the first material 11 is no longer visible between the webs 4, but that the regions between the webs 4 are covered by the second material 12.

1-15. (canceled)

16. A guide roller comprising a polygon body, wherein the polygon body comprises a base body made of at least a first material, wherein, over a circumference of the base body, the polygon body further comprises at least one web applied to the base body, wherein the at least one web comprises a second material which differs from the first material.

17. The guide roller according to claim 16, wherein the base body of the polygon body has an essentially cylindrical jacket surface arranged around a longitudinal axis of the base body.

18. The guide roller according to claim 16, wherein the first material is selected from the group consisting of aluminum, an aluminum alloy, steel, and a steel alloy.

19. The guide roller according to claim 16, wherein the base body at least partially comprises a coating comprising a third material.

20. The guide roller according to claim 16, wherein the second material of the at least one web is selected from the group consisting of a metal, a metal alloy, and a ceramic.

21. The guide roller according to claim 20, wherein the second material is selected from the group consisting of a wear-resistant steel, a non-iron material, and a non-iron alloy, and wherein the second material is further selected from the group consisting of tungsten, a tungsten alloy, nickel, and a nickel-base alloy.

22. The guide roller according to claim 20, wherein the ceramic comprises a molten oxide-ceramic powder.

23. The guide roller according to claim 16, wherein an adhesive layer is attached to the base body in a region of the at least one web.

24. The guide roller according to claim 17, wherein the at least one web is arranged parallel to the longitudinal axis of the base body.

25. The guide roller according to claim 16, wherein the polygon body comprising the base body and the at least one web is at least partially coated with a plating.

26. The guide roller according claim 16, wherein the guide roller is embodied as journal roller comprising roller journals attached to the polygon body.

27. The guide roller according to claim 16, wherein the guide roller comprises a support axis, and wherein the polygon body is rotatably mounted on the support axis.

28. A method for producing a guide roller according to claim 16, wherein the at least one web is applied to the base body of the polygon body by one of a deposition welding process, a thermal spraying process, a plasma transferred arc spraying process, a laser deposition welding process, or by an additive manufacturing process.

29. The method for producing a guide roller according to claim 28, wherein the at least one web attached to the base body is machined to provide a consistent outermost radial extension relative to a longitudinal axis of the base body.

30. The method for producing a a guide roller according to claim 28, wherein prior to applying the at least one web to the base body, an adhesive layer is at least partially applied to the base body.

31. The guide roller according to claim 16, wherein the base body at least partially comprises a coating comprising the second material.

32. The guide roller according to claim 19, wherein an adhesive layer is attached to the coating in a region of the at least one web.

33. The guide roller according to claim 17, wherein the at least one web is arranged helically on the jacket surface of the base body.
